(19) United States
(12) Patent Application Publication
(10) Pub. No.: US 2016/0025971 A1
(43) Pub. Date: Jan. 28, 2016

(54) EYELID MOVEMENT AS USER INPUT

(71) Applicants: William M. Crow, Sequim, WA (US); Katelyn Elizabeth Doran, Seattle, WA (US)

(72) Inventors: William M. Crow, Sequim, WA (US); Katelyn Elizabeth Doran, Seattle, WA (US)

(21) Appl. No.: 14/341,018

(22) Filed: Jul. 25, 2014

(51) Int. Cl. G02B 27/00; G02B 27/01; G06K 9/00; G06F 3/01

(52) U.S. Cl. CPC G02B 27/0093; G06F 3/013; G02B 27/017; G06K 9/00597; G02B 2027/0178; G02B 2027/0138; G02B 2027/014

(57) ABSTRACT

Embodiments related to eyelid tracking on a computing device are disclosed. For example, one disclosed embodiment provides a head-mounted computing device comprising an image sensor positioned to acquire an image of an eyelid when worn on a head, a logic system, and a storage system. The storage system comprises instructions stored thereon that are executable by the logic system to capture image data of an eyelid via the image sensor, track a movement of the eyelid via the image data, track an eyelid state based upon the captured image data of the eyelid, and take an action on the computing device based upon the eyelid state.

### BACKGROUND

Computing devices may utilize a variety of different user input mechanisms. For example, a computing device may utilize a positional input device, such as a mouse or a touch sensor, for interaction with a graphical user interface. Such user input devices provide a positional signal that, in combination with a selection mechanism (e.g. a button, tap gesture, etc.), allows a user to interact with a specified position on a graphical user interface.

### SUMMARY

Embodiments related to eyelid tracking on a computing device are disclosed. For example, one disclosed embodiment provides a head-mounted computing device comprising an image sensor positioned to acquire an image of an eyelid when worn on a head, a logic system, and a storage system. The storage system comprises instructions stored thereon that are executable by the logic system to capture image data of an eyelid via the image sensor, track a movement of the eyelid via the image data, track an eyelid state based upon the captured image data of the eyelid, and take an action on the computing device based upon the eyelid state.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows example hands-free interactions between a user and a graphical user interface via a head-mounted display device.

FIG. 2 shows an example of a head-mounted display device.

FIGS. 3A-3C are flow charts illustrating an example method for controlling a computing device based on an eyelid state of a user.

FIG. 4 shows a block diagram of a non-limiting example of a computing system.

### DETAILED DESCRIPTION

Eye gaze tracking may be used a mechanism for interacting with a graphical user interface. For example, a location at which a gaze is determined to intersect a graphical user interface may be used as a position signal for the graphical user interface, analogous to that provided by a traditional cursor that is controlled by a computer mouse or the like.

Eye gaze tracking may be used with many types of computing devices. As one non-limiting example, eye gaze tracking may be used to interact with a head-mounted display (HMD). A HMD device that utilizes eye gaze tracking may rely on touch or other manual inputs to the HMD device, or to a device in communication with the HMD device, for performing a selection input. However, under certain conditions, it may be desirable for the user to interact with the HMD device in a hands-free mode, leaving the user's hands free for other tasks. Possible hand-free solutions for HMD devices may include voice recognition control and additional cameras/sensors that detect hand poses and gestures. However, such input mechanisms are relatively intrusive, not private, and/or may not be truly hands-free.

Thus, embodiments are disclosed herein that relate to the use of eyelid gestures to provide a low intrusive solution for hands-free interaction. For example, existing sensors (e.g., eye-tracking cameras) on an HMD device may be used to track both eye and eyelid movement in order to detect a gaze direction of the user (to determine which graphical user interface element the user intends to select, for example) and to identify a selection input based on an intentional eyelid closure.

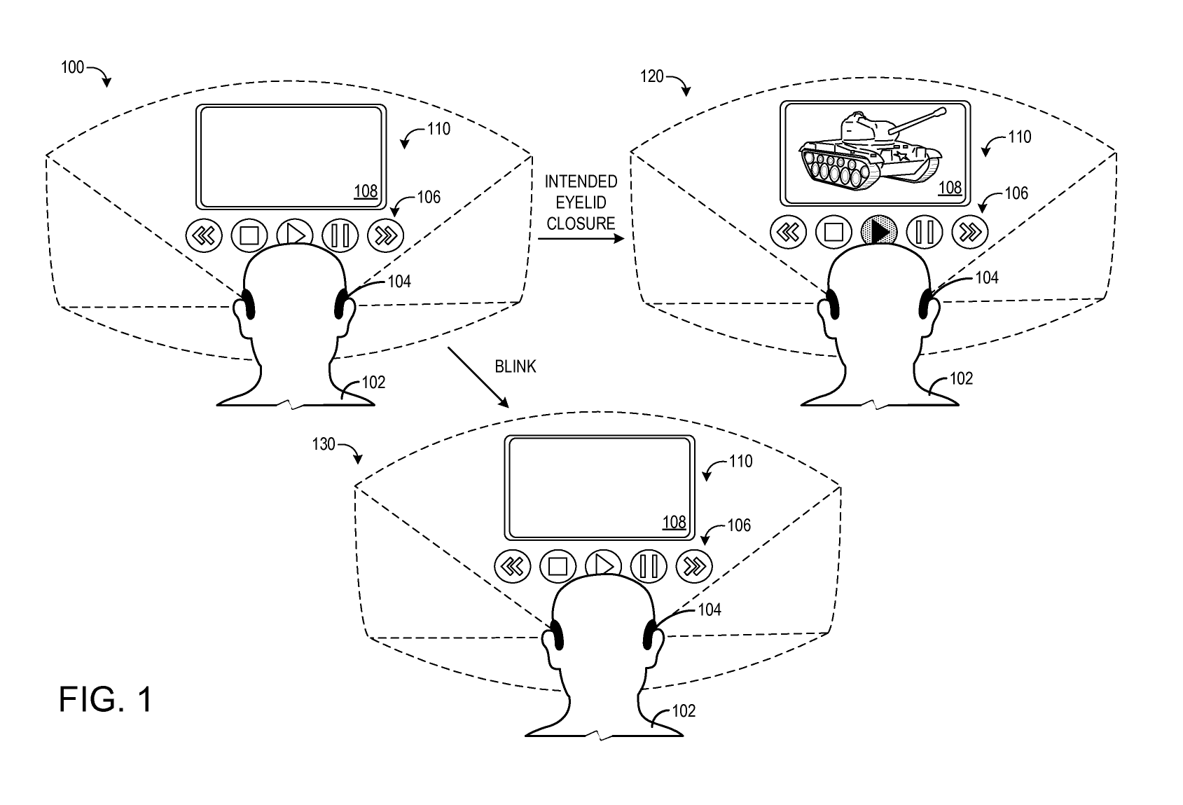

FIG. 1 illustrates a series of example hands-free interactions between a user and a graphical user interface via eye gestures detected by an HMD device. Specifically, FIG. 1 shows an over-the-shoulder schematic perspective of a user 102 viewing a graphical user interface 110 displayed via an HMD device 104. The graphical user interface 110 of FIG. 1 comprises a holographic television 108 and a plurality of control elements 106 each configured to control one or more aspects of the playback of media on holographic television 108. The depicted control elements 106 include a play button, stop button, pause button, fast forward button, and reverse button, but it will be understood that such a user interface may include any suitable controls. Further, while FIG. 1 illustrates virtual objects, in some embodiments user 102 may also view real world objects along with the virtual objects via a see-through near-eye display of the HMD device 104. It will be understood that the depicted holographic television 108 is provided as an example of graphical user interface displayed to user 102, and that any other suitable user interface may be displayed. Examples include, but are not limited to, other entertainment-related user interfaces (e.g. gaming interfaces and audio players), browsers (web, file, etc.), productivity software-related interfaces, communication interfaces, operating system/firmware/hardware control interfaces, etc.

Eye gesture input from user 102 may be used to control one or more aspects of the HMD device 104. For example, the HMD device 104 may receive image data from one or more sensors (described in more detail below), and identify states such as eye gaze direction, eye gaze classification, and/or eyelid movement for controlling the HMD device 104. While described in the context of an HMD device, it will be understood that the user interface interactions described herein may be used with any other computing system configured to receive input via image sensors. Examples include, but are not limited to, desktop computers, laptop computers, tablet computers, smart phones, and other wearable computing systems.

In the example illustrated in FIG. 1, user 102 may fix a gaze on a desired user interface control element and select the desired user interface control element by performing an intentional eyelid closure. For example, in a first illustrated interaction 100 between the user 102 and graphical user interface 110, the HMD device 104 detects that the user 102 has fixed her or her gaze on the play button of the control elements 106. The HMD device 104 may detect the gaze fixation based on feedback from one or more eye-tracking sensors that determine the gaze direction of the user over time, and determine if the user's gaze intersects any user interface elements. If the user's gaze lingers on a particular user interface element for at least a threshold duration, it may be determined that the user's gaze is fixed on that user interface element.

If the user 102 performs an intentional eyelid closure while gazing at a user interface element, the HMD device 104 may interpret the eyelid closure as a selection input. In a second illustrated interaction 120, user 102 has performed an intentional eyelid closure based on eyelid movement as tracked by the one or more eye-tracking sensors. Based on the location of the intersection between the user's gaze and the graphical user interface 110 at the time of the intentional eyelid closure, the HMD device 104 determines that the user intended to select the play button, and thus the play button is selected and a media content item begins to play on the holographic television 108. On the other hand, if the user does not perform an intentional eyelid closure, but instead an unintentional blink, no selection input is made. Accordingly, as shown in a third illustrated interaction 130, the graphical user interface 110 remains the same as it was during the previous interaction 100.

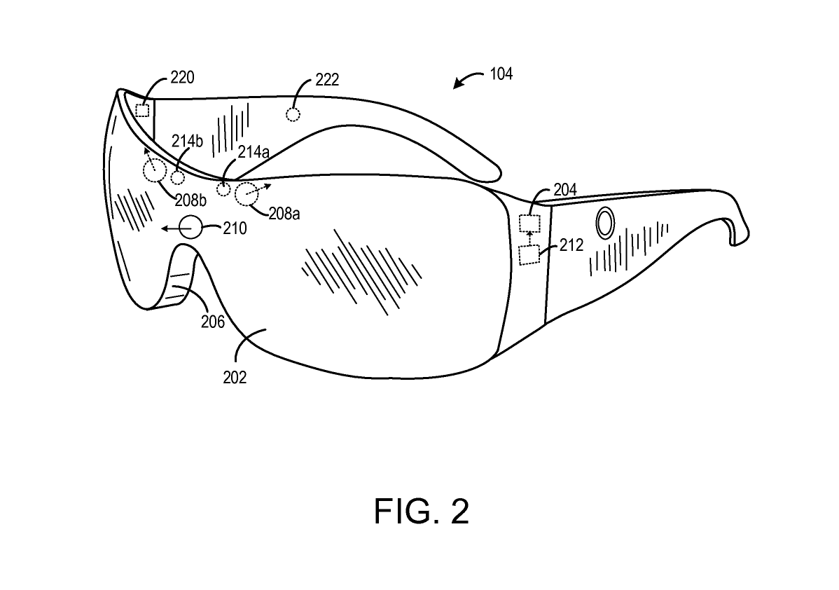

FIG. 2 shows a non-limiting example of the HMD device 104 in the form of a pair of wearable glasses with a see-through display 202. It will be appreciated an HMD device may take any other suitable form in which a transparent, semi-transparent, and/or non-transparent display is supported in front of a viewer's eye or eyes. Further, embodiments described herein may be used with any other suitable eye tracking system, including but not limited to eye tracking systems for mobile computing devices, laptop computers, desktop computers, tablet computers, other wearable computers, etc.

The HMD device 104 includes a see-through display 202 and a controller 204. The see-through display 202 may enable images such as holographic objects to be delivered to the eyes of a wearer of the HMD device. The see-through display 202 may be configured to visually augment an appearance of a real-world, physical environment to a wearer viewing the physical environment through the transparent display. In one example, the display may be configured to display one or more UI objects on a graphical user interface. In some embodiments, the UI objects presented on the graphical user interface may be virtual objects overlaid in front of the real-world environment. Likewise, in some embodiments, the UI objects presented on the graphical user interface may incorporate elements of real-world objects of the real-world environment seen through the see-through display 202. In either case, the UI objects may be selected via eye gaze tracking.

Any suitable mechanism may be used to display images via the see-through display 202. For example, the see-through display 202 may include image-producing elements located within lenses 206 (such as, for example, a see-through Organic Light-Emitting Diode (OLED) display). As another example, the see-through display 202 may include a display device (such as, for example a liquid crystal on silicon (LCOS) device or OLED microdisplay) located within a frame of HMD device 104. In this example, the lenses 206 may serve as a light guide for delivering light from the display device to the eyes of a wearer. Such a light guide may enable a wearer to perceive a 3D holographic image located within the physical environment that the wearer is viewing, while also allowing the wearer to view physical objects in the physical environment, thus creating a mixed reality environment.

The HMD device 104 may also include various sensors and related systems to provide information to the controller 204. Such sensors may include, but are not limited to, one or more inward facing image sensors 208a and 208b, one or more outward facing image sensors 210, an inertial measurement unit (IMU) 212, and a microphone 220. The one or more inward facing image sensors 208a, 208b may be configured to acquire image data in the form of gaze tracking data from a wearer's eyes (e.g., sensor 208a may acquire image data for one of the wearer's eye and sensor 208b may acquire image data for the other of the wearer's eye). The HMD device may be configured to determine gaze directions of each of a wearer's eyes in any suitable manner based on the information received from the image sensors 208a, 208b. For example, one or more light sources 214a, 214b, such as infrared light sources, may be configured to cause a glint of light to reflect from the cornea of each eye of a wearer. The one or more image sensors 208a, 208b may then be configured to capture an image of the wearer's eyes. Images of the glints and of the pupils as determined from image data gathered from the image sensors 208a, 208b may be used by the controller 204 to determine an optical axis of each eye. Using this information, the controller 204 may be configured to determine a direction the wearer is gazing. The controller 204 may be configured to additionally determine an identity of a physical and/or virtual object at which the wearer is gazing.

The one or more outward facing image sensors 210 may be configured to receive physical environment data from the physical environment in which the HMD device 104 is located. Data from the outward facing image sensors 210 may be used to detect movements within a field of view of the display 202, such as gesture-based inputs or other movements performed by a wearer or by a person or physical object within the field of view. In one example, data from the outward facing image sensors 210 may be used to detect a selection input performed by the wearer of the HMD device, such as a gesture (e.g., a pinching of fingers, closing of a fist, etc.), that indicates selection of a UI object displayed on the display device. Data from the outward facing sensors may also be used to determine direction/location and orientation data (e.g. from imaging environmental features) that enables position/motion tracking of the HMD device 104 in the real-world environment.

The IMU 212 may be configured to provide position and/or orientation data of the HMD device 104 to the controller 204. In one embodiment, the IMU 212 may be configured as a three-axis or three-degree of freedom position sensor system. This example position sensor system may, for example, include three gyroscopes to indicate or measure a change in orientation of the HMD device 104 within 3D space about three orthogonal axes (e.g., x, y, z) (e.g., roll, pitch, yaw). The orientation derived from the sensor signals of the IMU may be used to display, via the see-through display, one or more virtual UI objects in three degrees of freedom.

In another example, the IMU 212 may be configured as a six-axis or six-degree of freedom position sensor system. Such a configuration may include three accelerometers and three gyroscopes to indicate or measure a change in location of the HMD device 104 along the three orthogonal axes and a change in device orientation about the three orthogonal axes. In some embodiments, position and orientation data from the outward facing image sensors 210 and the IMU 212 may be used in conjunction to determine a position and orientation of the HMD device 104.

The HMD device 104 may also support other suitable positioning techniques, such as GPS or other global navigation systems. Further, while specific examples of position sensor systems have been described, it will be appreciated that any other suitable position sensor systems may be used. For example, head pose and/or movement data may be determined based on sensor information from any combination of sensors mounted on the wearer and/or external to the wearer including, but not limited to, any number of gyroscopes, accelerometers, inertial measurement units, GPS devices, barometers, magnetometers, cameras (e.g., visible light cameras, infrared light cameras, time-of-flight depth cameras, structured light depth cameras, etc.), communication devices (e.g., WIFI antennas/interfaces), etc.

Continuing with FIG. 2, the controller 204 may be configured to record multiple eye gaze samples over time based on information detected by the one or more inward facing image sensors 208a, 208b. For each eye gaze sample, eye tracking information and, in some embodiments, head tracking information (from image sensors 210 and/or IMU 212) may be used to estimate an origin point and a direction vector of that eye gaze sample to produce an estimated location at which the eye gaze intersects the see-through display. Examples of eye tracking information and head tracking information used to determine an eye gaze sample may include an eye gaze direction, head orientation, eye gaze velocity, eye gaze acceleration, change in angle of eye gaze direction, and/or any other suitable tracking information. In some embodiments, eye gaze tracking may be recorded independently for both eyes of the wearer of the HMD device 104.

Further, the controller 204 may be configured to track eyelid movement based on image information collected by the one or more inward facing image sensors 208a, 208b. For example, each inward facing image sensor may be configured to capture images of a respective eyelid of the wearer of the HMD device. Similar to the eye gaze detection described above, the controller 204 may be configured to process the images to track, for each eyelid, an eyelid state. For example, the controller may be configured to determine that an eyelid moves from an open position to a closed position, that an eyelid moves from a closed position to an open position, as well as duration of eyelid closure, velocity and/or acceleration of eyelid movement, and/or other parameters. Based on the tracked eyelid state, the controller 204 may determine if a detected eyelid closure is an intentional eyelid closure, intended as a user input, for example, or if the eyelid closure is an unintentional closure, e.g., a blink. In some embodiments, eyelid state tracking may be recorded independently for both eyes of the wearer of the HMD device 104.

In some examples, the controller 204 may also determine a user state based on the eyelid state, such as a facial expression of the user, which may be used as input to a computing device. In further examples, the controller may be configured to manage the power consumption of one or more subsystems of the HMD device 104 based on the tracked eyelid state. Additional information regarding user interface control and power management based on eyelid state will described in more detail below.

The HMD device 104 may also include one or more microphones, such as microphone 220, that capture audio data. Further, audio outputs may be presented to the wearer via one or more speakers, such as speaker 222. In some embodiments, the microphone system may be configured to provide audio feedback indicating selection of a UI object presented on a graphical user interface displayed on the see-through display.

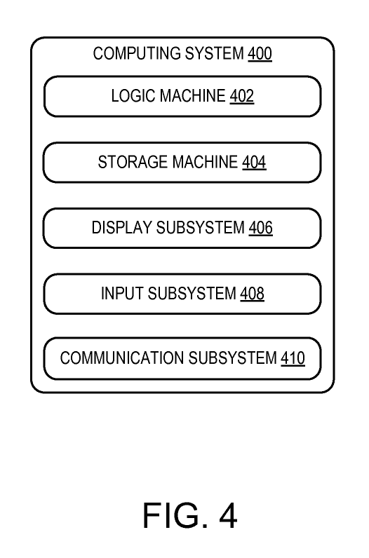

The controller 204 may include a logic machine and a storage machine, discussed in more detail below with respect to FIG. 4, in communication with the various sensors and display of the HMD device. In one example, the storage machine may include instructions that are executable by the logic machine to capture image data of an eyelid via an image sensor, track a movement of the eyelid via the image data, track an eyelid state based upon the captured image data of the eyelid, and take an action (e.g. an action related to a user interaction) on the computing device based upon the eyelid state. In another example, the storage machine may include instructions that are executable by the logic machine to detect an eyelid closure, and if the eyelid closure exceeds a threshold condition, then reduce a power consumption of a subsystem of the device based upon the detected eyelid closure. In a further example, the storage machine may include instructions that are executable by the logic machine to track gaze direction based upon image data of the eye as acquired by the eye tracking camera, detect an eyelid closure from the image data, determine whether the eyelid closure was a blink or an intended user input, if the eyelid closure is determined to be an intended user input, then take an action based upon a location at which the gaze direction intersects the displayed user interface, and if the eyelid closure is determined to be a blink, then not take the action.

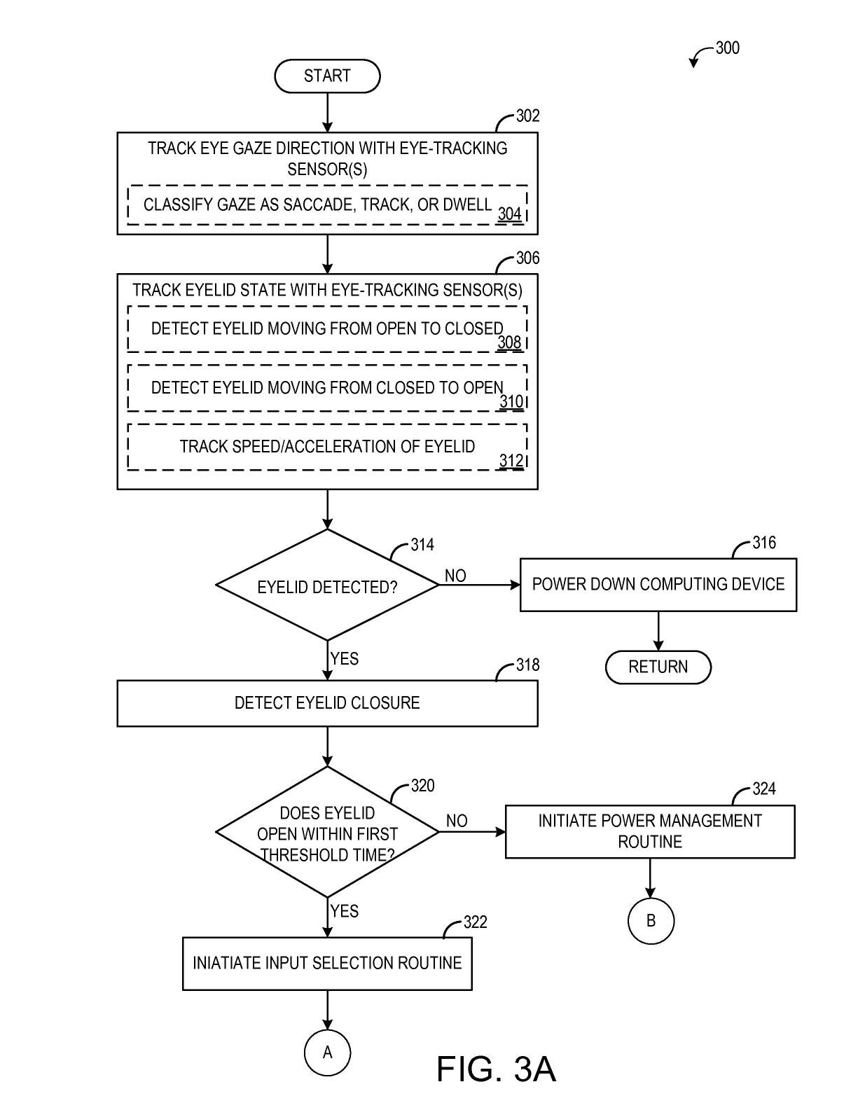

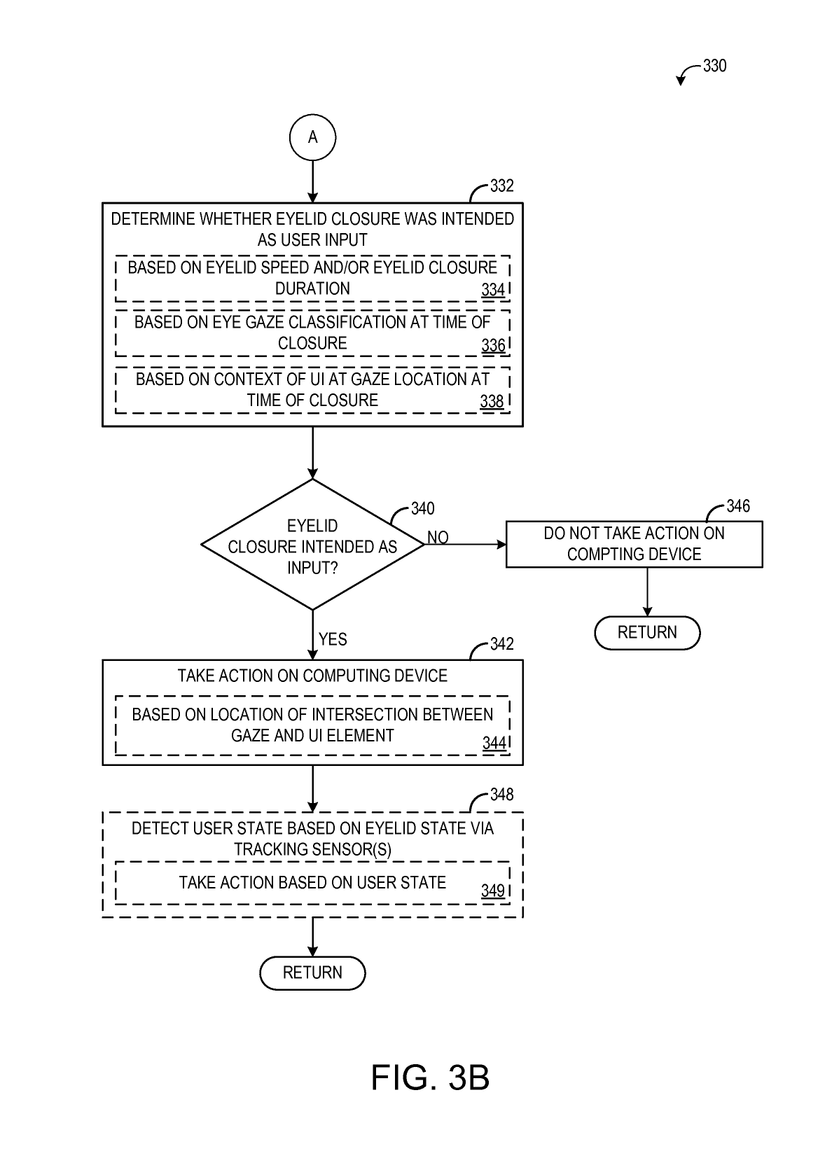

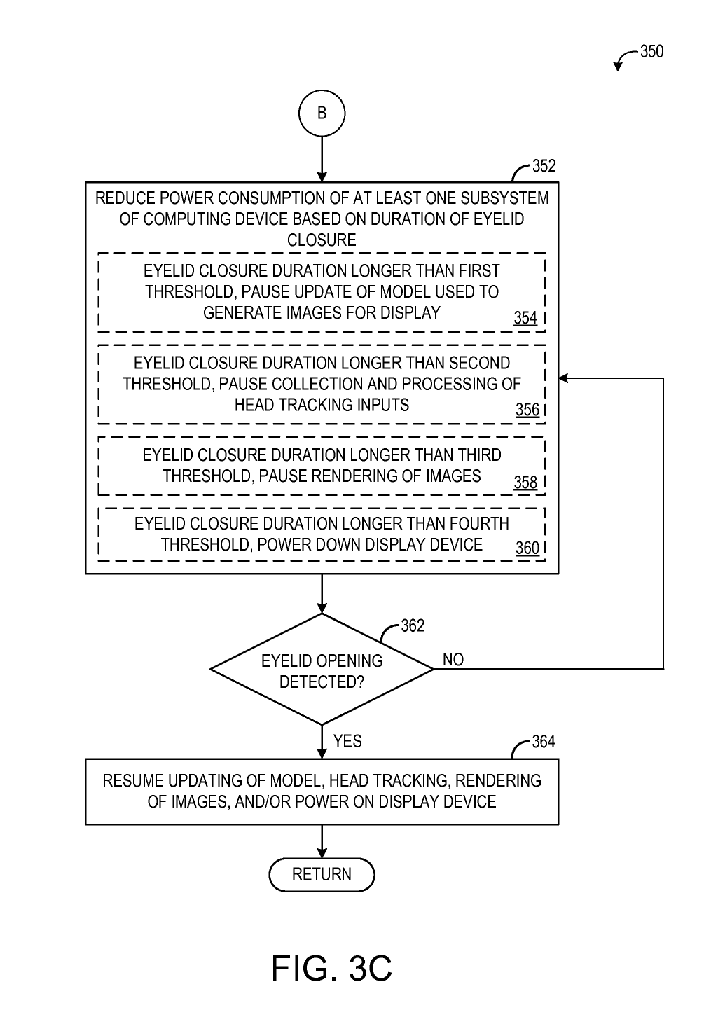

FIGS. 3A-3C illustrate an example of a method 300 for controlling a computing device based on an eyelid state of a user. Method 300 may be performed by a suitable computing device, including but not limited to the HMD device 104 described above with respect to FIGS. 1 and 2. In such an implementation, method 300 may be performed by the controller 204 of the HMD device 104, for example, in response to feedback from one or more sensors, such as the one or more inward facing image sensors 208a, 208b.

At 302, method 300 includes tracking user eye gaze direction with one or more eye-tracking sensors, such as via inward facing image sensors 208a and 208b described above with respect to FIG. 2. Tracking the eye gaze direction may also include, as indicated at 304, classifying the gaze of the user as a saccade gaze, tracking gaze, or dwell gaze. As explained previously, the HMD device may track the gaze of the user over time, and the controller of the HMD device may be configured to determine not only the direction of the user's gaze, but also if the user's gaze is moving or fixed at a particular location. User eye movements may be classified, for example, as saccade, where rapid eye movements are used to scan a scene; tracking, where the user's gaze moves intentionally across a field of view, for example following motion of an object; and dwell, where the user's gaze is fixed at a particular location.

At 306, method 300 includes tracking an eyelid state with the one or more eye-tracking sensors. The eyelid state may be tracked for one or both eyelids, based on image information collected from the sensors, for example. Based on the image information, the eyelid state may be determined. This may include, at 308, detecting an eyelid moving from an open to a closed position, detecting an eyelid moving from a closed to an open position, as indicated at 310, and/or tracking the speed and/or acceleration of the eyelid movements, as indicated at 312.

Additionally, image data from the eye-tracking sensors may be used to determine if an eyelid is detectable. For example, in some instances, the eye-tracking sensors may detect an absence of the eye and/or eyelid, indicating that the HMD device has been moved out of view of the eye-tracking sensors (e.g., that the HMD device is no longer being worn by the user). Thus, as indicated at 314, method 300 may determine if an eyelid is detected, based on feedback from the eye-tracking sensors.

If an eyelid is not detected, method 300 may comprise, at 316, powering down the computing device. Powering down may include putting the HMD device into a power-saving mode, fully shutting off the HMD device, or making any other suitable change to power state. An example power-saving mode may include pausing all head and eye-tracking processes, pausing image rendering and image display, etc. In some examples, during the power-saving mode, the HMD device may be configured to receive and process inputs from the IMU sensor, for example, in order to detect movement of the HMD device and resume normal operation in response to the movement (as the movement may be indicative of the user resuming wearing of the HMD device). As another example, to resume normal operation after placement in the power-saving mode, a user input to an input button may be made. It will be understood that the HMD device may exit a power-saving mode based upon any other suitable input or event. Further, it is to be understood that at any time during the execution of method 300, if an absence of one or more eyelids is detected, the HMD device may be powered down.

In another example, the eye tracking system may be continuously run in a low power mode (for example, using tracking for only one eye, and/or running at a much lower sampling rate), and detection of the presence of an eye or eyelid may be used as an indication to resume normal operation. Another example for returning to normal operation may include using a form of low power sensing technology (pressure, optical, capacitive proximity, etc.) that detects when the device is placed on the head.

Returning to 314, if an eyelid is detected, method 300 comprises, at 318, detecting an eyelid closure based on the tracked eyelid state, and at 320, determining if the closed eyelid opens within a first threshold time used for power state control. If the eyelid opens within the first threshold time used for power state control, then method 300 proceeds to 322 to initiate an input selection determination process (branch A of the method 300), which will be described in more detail below with respect to FIG. 3B. If the eyelid does not open within the first threshold time, method 300 proceeds to 324 to initiate a power management process (branch B of the method 300), which will be described in more detail with respect to FIG. 3C.

Referring next to FIG. 3B, the input selection process 330 (branch A) is initiated responsive to an eyelid closure that is less than the first threshold time. During the input selection process, the eyelid closure is assessed to identify if the eyelid closure was performed intentionally as an input, or if the eyelid closure was performed unintentionally as an incidental blink. Accordingly, at 332, method 300 includes determining whether the eyelid closure was intended as user input. Whether the eyelid closure is intended user input may be determined based on a variety of factors, such as eyelid movement characteristics and/or the context/direction of the user gaze. Thus, method 300 may include, at 334, determining whether the eyelid closure was intended as user input based on eyelid speed and/or eyelid closure duration. For example, an eyelid closure intended as user input may be made more slowly than a blink and/or the closure may last longer than a blink. As such, the eyelid closure may be determined to be intentional if the eyelid closure lasts past a blink duration threshold and/or if the eyelid moves at a speed slower than a blink speed threshold.

As described above, the eyelid tracking process may include analyzing images received from the eye tracking cameras to recognize multiple different eyelid states. These states may include such information as the first appearance of the eyelid in the top of the frame as it begins to occlude the eye, the time when the eyelid is closed and relatively stationary, and the beginning of the eyelid's upward motion to uncover the eye. In some implementations, machine learning techniques may be used to identify these different visual states of the eyelid position and transitions. Further, in some implementations, state machine logic may determine if the sequence of states from closing, to closed, to opening occurs within a short enough period of time to be considered a “blink” rather than a more conscious and deliberate eye closure. By recognizing a specific pattern of eyelid closing and opening velocity, combined with a duration of the eyelid closed period, a distinct signature may be determined that may reliably be interpreted as the selection input.

In addition to detected eyelid speed as a determining factor to disambiguate between a blink vs. intentional input, eyelid acceleration and deceleration may also be tracked to differentiate blinks from intentional closures. During eyelid closure and opening, the speed, acceleration, and deceleration may all be independently tracked. An eye state (e.g., intentional closure) may be detected based on the sequence of eyelid closure, and eyelid opening, along with the duration of the closure, and the aforementioned speed, acceleration, and deceleration measurements during both opening and closing. Additionally, a particular pose of the eyelid when closed may be detected. A conscious eyelid closure may typically be a stronger closure than a subconscious blink, and this may result in a detectable difference in appearance of the closed eyelid.

The determination of whether the eyelid closure was intended as user input may further be made based on an eye gaze classification at the time of the eyelid closure, as indicated at 336. As discussed previously, an eye gaze of the user may be classified as saccade, tracking, or dwell. As it is unlikely the user would intend to close his or her eyes as an input mechanism without first fixing his or her gaze on a selectable user interface element, eyelid closures made during saccade or tracking gazes may be assumed to be unintentional. On the other hand, if the eyelid closure was made during a dwell gaze, the eyelid closure may be determined to be an intended user input, possibly in combination with other factors.

As another possible factor, the determination of whether the eyelid closure was intended as a user input also may be based upon the context of the gaze location on the user interface at the time of the eyelid closure, as indicated at 338. For example, if the user was looking at a selectable user interface element at the time of the eyelid closure, the likelihood that the eyelid closure is intended as user input may be higher than if the user is looking at a non-user interface object, for example.

Further, as explained above, temporal factors also may be considered. For example, as mentioned above, eyelid closures that occur within a defined time window may be more likely to be an intentional user input than eyelid closures outside of the time window. Such time windows may be associated with user interface elements that the user is targeting, for example, and may relate to when a selection input is valid and might be expected. Eyelid activity outside these expected time windows may be ignored, thus helping to reduce the chances of false positives or other detection errors. In addition, eye gaze classification information (e.g. saccadic movement, tracking movement, dwell) also may be used to filter eyelid activity that is outside the periods of eye dwell, as it may be less likely that a user intends to make selection inputs during non-dwell eye gaze states.

In some implementations, each eye state and eyelid state may be tracked independently. Thus, the HMD device may detect non-bilateral eyelid actions. These unique “winks” may provide a mechanism to allow the user to signal different actions in addition to the basic selection action.

Continuing with FIG. 3B, at 340, the input selection process of method 300 determines if the eyelid closure was intended as input, based on factors such as those described above. If it is determined that the eyelid closure was intended as input, the input selection process of method 300 comprises, at 342, taking an action on the computing device based on the location of the intersection between the user gaze and a user interface element, as indicated at 344, when the eyelid closure was detected. On the other hand, if it is determined the eyelid closure was not intended as user input, for example if it is determined that the eyelid closure was an unintentional blink, then the input selection process of method 300 comprises, at 346, not taking the action on the computing device.

In some examples, in addition to tracking eyelid movement in order to detect a user input, the input selection process of method 300 may optionally detect a user state based on the eyelid state as tracked by the eye-tracking sensors, as indicated at 348. The user state may comprise, for example, a user emotional state that is manifested by an expression detectable by the eyelid state. For example, a user display of frustration, anger, surprise, happiness, etc., each may have a corresponding facial expression. The facial expressions may be detected based on the eyelid movement, alone or in combination with other facial features (such as eyebrow position, presence or absence of wrinkles around the eyes, etc.). In some examples, as indicated at 349, the computing device may take an action based on the detected user state.

FIG. 3C shows a flow diagram depicting an example power management process 350 (e.g., branch B) of method 300. Briefly, if it is known from eyelid tracking information that the user cannot see the display, then one or more power-consuming operations of the HMD can be temporarily suspended. As described above, the power management process is initiated in response to the eyelid remaining closed for at least a first threshold duration. The first threshold duration may be a suitable duration, such as a duration longer than a blink, a duration longer than an intentional eyelid closure intended as user input, or other suitable duration.

Once an eyelid closure of at least the first threshold duration is detected, the process begins by reducing power consumption of at least one subsystem of the computing device based on the duration of the eyelid closure, as indicated at 352. The process may utilize, for example, motion and static pattern recognition image processing techniques, combined with machine learning-based analysis to detect transient (e.g., blink) and extended eyelid motion and states, allowing the HMD device to make power management decisions based on whether the user can see the display of the HMD device. Further, the HMD device may make continuous micro-adjustments to power consumption based on known information about the user's attention and focus. In the most direct case, the system may disable all the sensors, processing, and displays associated with creating images for the head mounted displayed when it is known that the user cannot see the displays. However, as explained in more detail below, if all the sensors, processing, and displays are disabled, a relatively long latency period may occur prior resumption of ordinary HMD image display operation after the user opens his or her eyes. Thus, in other examples, such latency may be avoided except where reasonably expected by selectively and/or sequentially powering down certain subsystems of the HMD device based on a duration of the detected eyelid closure.

The eyelid state detection process for the power management process may begin with analyzing images received from eye tracking cameras to recognize multiple different eyelid states. These states include the first appearance of the eyelid in the top of the frame as it begins to occlude the eye, the time when the eyelid is closed and relatively stationary, and the beginning of the eyelid's upward motion to uncover the eye.

When a closed eyelid state is detected for a pre-determined period of time, the appropriate head tracking, display content computation, and/or display projection subsystems may be notified to pause activity. Then, when the first motion associated with the eyelid opening is detected, the appropriate subsystems may be immediately notified to resume tracking, display content computation, and display projection. The quiescent state for these subsystems may be maintained to allow them to collectively restart in the time it takes for the eyelid to expose the eye after the first upward motion is detected.

Depending on the duration of the closed eyelid period, each subsystem may assume a different quiescent state. Thus, as indicated at 354, if the eyelid closure is longer than the first threshold duration, the power management process of method 300 may comprise pausing an update of the model used to generate images for display on the display device of the HMD device. As explained above with respect to FIG. 2, the HMD device may include a see-through display where virtual objects are displayed overlaid on real objects in the physical scene. To accomplish this, in some implementations, a position and orientation of the user's head is determined and a 3-D model may be built to represent the physical scene as viewed by the user. Based on the 3-D model, the various virtual objects may be rendered and positioned for display. As the user moves his or her head and/or the virtual objects and physical scene changes, the model may be updated. Thus, at 354, adjustments to the model may be paused and the last used model may be relied on to generate the images for display, rather than an updated model, thus saving processing power and reducing power consumption.

Reducing the power consumption based on the eyelid closure duration further may include, if the eyelid closure is longer than a second threshold, pausing the collection and/or processing of head tracking inputs, as indicated at 356. Head tracking may have a longer re-initialization time than updating the model. Therefore, disabling the head tracking may be deferred until it is determined that the eyelids are closed for an extended period, e.g., longer than the first duration.

Further, reducing the power consumption based on eyelid closure duration may include, at 358, pausing the rendering of images on the display device if the eyelid closure duration exceeds a third threshold duration. Further, at 360, reducing the power consumption based on eyelid closure duration may include powering down the display device if the eyelid closure duration exceeds a fourth threshold.

In some examples, the second threshold may longer than the first threshold duration, the third threshold may be longer than the second, and the fourth threshold may be longer than the third. However, in other examples, one or more of the thresholds may be of similar length, such that more than one subsystem is powered down at a time. In still further examples, the order of which subsystems are powered down may be different than the order presented above; for example, in some examples the interruption of head-tracking may be the last subsystem to be powered down. It will further be understood that these thresholds and power reducing actions are described for the purpose of example, and that any suitable thresholds and associated power reducing actions may be utilized.

Continuing, the power management process of method 300 includes, at 362, determining whether an eyelid opening is detected. If an eyelid opening is not detected, then method 300 loops back to 352 to continue to power down computing device subsystems based on the duration of the eyelid closure. If an eyelid opening is detected, for example, once the eyelid begins to move from closed to open and before the eyelid is fully open, the power management process of method 300 includes resuming the updating of the model, resuming head-tracking, resuming rendering of images, and/or powering on the display device, thus restoring the computing device back to ordinary use and associated power consumption.

Thus, the power consumption of the computing device may be managed based on the detected eyelid closure state. The above-described examples of which subsystems are powered down, based on the relative length of the eyelid closure, are provided as example and are not meant to be limiting, as other subsystems may be powered down and/or in different order. For example, as soon as the eyelid close is detected, the render processing for the scene may be paused, so even during a transition as brief as a normal eye blink, it may be possible to eliminate rendering for individual frames. Then, if the closed eye state extends over multiple frames, then the display projection may be disabled, resulting in significant power reductions. Likewise, head tracking may have a longer re-initialization time. As such, disabling this tracking may be deferred until it is determined that the eyelids are closed for an extended period. In this case, a user may reasonably anticipate a brief start-up latency when the eyelids are re-opened.

Additionally, as described above with respect to FIG. 3A, the HMD device may also be configured to detect the absence of either eyes or eyelids, indicating that the device has been removed, or moved away from the eyes. Detecting this event may also be used to trigger appropriate actions as configured by the user, including automatic logoff and/or shutdown to a suspended operating state.

While the two different branches of the method 300 described above are presented as separate processes, where one process is performed if the eyelid closure is relatively short (e.g., the selection input process is initiated when the eyelid closure is less than a threshold duration) and the other process is performed if the eyelid closure is relatively long (e.g., the power management process is performed if the eyelid closure is longer than the first threshold duration), it is to be understood that in some examples, the two process are not exclusive and may be performed simultaneously. For example, an intentional eyelid closure intended as user input also may be of sufficient duration to initiate the power management process, such that at least some portions of the HMD device are powered down during the intentional eyelid closure.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 4 schematically shows a non-limiting embodiment of a computing system 400 that can enact one or more of the methods and processes described above. Computing system 400 is shown in simplified form. Computing system 400 may take the form of one or more personal computers, server computers, tablet computers, home-entertainment computers, network computing devices, gaming devices, mobile computing devices, mobile communication devices (e.g., smart phone), and/or other computing devices.

Computing system 400 includes a logic machine 402 and a storage machine 404. Computing system 400 may optionally include a display subsystem 406, input subsystem 408, communication subsystem 410, and/or other components not shown in FIG. 4.

Logic machine 402 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 404 includes one or more physical devices configured to hold instructions executable by the logic machine to implement the methods and processes described herein. When such methods and processes are implemented, the state of storage machine 404 may be transformed—e.g., to hold different data.

Storage machine 404 may include removable and/or built-in devices. Storage machine 404 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 404 may include volatile, nonvolatile, dynamic, static, read/write, read-only, random-access, sequential-access, location-addressable, file-addressable, and/or content-addressable devices.

It will be appreciated that storage machine 404 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 402 and storage machine 404 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

Display subsystem 406 may be used to present a visual representation of data held by storage machine 404. This visual representation may take the form of a graphical user interface (GUI). As the herein described methods and processes change the data held by the storage machine, and thus transform the state of the storage machine, the state of display subsystem 406 may likewise be transformed to visually represent changes in the underlying data. Display subsystem 406 may include one or more display devices utilizing virtually any type of technology, such as displays 202 of the HMD device 104 shown in FIG. 2. Such display devices may be combined with logic machine 402 and/or storage machine 404 in a shared enclosure, or such display devices may be peripheral display devices.

Input subsystem 408 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker (e.g., outward facing image sensors 210), eye tracker (e.g., inward facing image sensors 208a and 208b), accelerometer, and/or gyroscope for motion detection and/or intent recognition; as well as electric-field sensing componentry for assessing brain activity; any of the sensors described above with respect to FIG. 2; or any other suitable sensor.

When included, communication subsystem 410 may be configured to communicatively couple computing system 400 with one or more other computing devices. Communication subsystem 410 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 400 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and sub-combinations of the various processes, systems and configurations, and other features, functions, acts, and/or properties disclosed herein, as well as any and all equivalents thereof.

1. A head-mounted computing device, comprising:
an image sensor positioned to acquire an image of an eyelid when worn on a head;
a logic system; and
a storage system comprising instructions stored thereon that are executable by the logic system to
capture image data of an eyelid via the image sensor,
track a movement of the eyelid via the image data,
track an eyelid state based upon the captured image data of the eyelid, and
take an action on the computing device based upon the eyelid state.

2. The computing device of claim 1, wherein the instructions executable to track the eyelid state are further executable to detect an eyelid closure lasting at least a first threshold duration, and wherein the action comprises reducing power consumption of at least one subsystem of the computing device.

3. The computing device of claim 2, wherein the at least one subsystem of the computing device comprises a display device, and wherein if the eyelid closure lasts between the first threshold duration and a second, longer threshold duration, the action comprises pausing an update of a model used to generate one or more images for display on the display device.

4. The computing device of claim 3, wherein if the eyelid closure lasts between the second threshold duration and a third threshold duration that is longer than the second threshold duration, the action comprises powering off the display device.

5. The computing device of claim 1, wherein the instructions are further executable to detect an absence of the eyelid based on the captured image data from the image sensor, and wherein the action comprises reducing power consumption of at least one subsystem of the computing device in response to an absence of the eyelid being detected.

6. The computing device of claim 1, wherein the instructions executable to track the eyelid state are further executable to detect a change in eyelid state from an open state to a closed state, and to determine whether the change in eyelid state from the open state to the closed state corresponds to an intentional eyelid closure or an incidental blink.

7. The computing device of claim 6, wherein the instructions are executable to distinguish an intentional eyelid closure from an incidental blink based on the change in eyelid state meeting a threshold condition.

8. The computing device of claim 7, wherein the threshold condition comprises the eyelid being closed for a threshold duration.

9. The computing device of claim 7, wherein the threshold condition comprises one or more of the eyelid moving from being open to being closed at less than a threshold velocity, the eyelid moving from being open to being closed at less than a threshold acceleration, and a pose of the eyelid.

10. The computing device of claim 7, wherein the instructions are executable to:
capture image data of an eye associated with the eyelid via the image sensor;
track a user gaze based on the image data of the eye; and
classify the user gaze as being a saccade gaze, tracking gaze, or dwell gaze,
wherein the intentional eyelid closure is further determined based on a user gaze at the time of the eyelid closure being a dwell gaze, and
wherein no user interaction action is taken in response to an eyelid closure if the user gaze is classified as a saccade or tracking gaze.

11. The computing device of claim 10, wherein the action taken on the computing device is a user interaction based on a location of an intersection of a user gaze with a user interface element at time of the intentional eyelid closure.

12. A method for managing a device, comprising:
detecting an eyelid closure;
if the eyelid closure exceeds a threshold condition, then reducing a power consumption of a subsystem of the device based upon the detected eyelid closure.

13. The method of claim 12, wherein the threshold condition comprises the eyelid being closed for a threshold duration.

14. The method of claim 12, wherein reducing the power consumption of a subsystem of the device comprises one or more of pausing adjustments to a model used to generate images for display on a display device of the device, pausing rendering of the images on the display device, pausing processing and/or collection of head-tracking inputs, and powering off the display device.

15. The method of claim 14, wherein if the eyelid closure exceeds a first threshold duration, reducing the power consumption of a subsystem of the device comprises pausing adjustments to the model used to generate the images for display, and wherein if the eyelid closure exceeds a second, longer threshold duration, reducing the power consumption of a subsystem of the device comprises powering off the display device.

16. The method of claim 12, further comprising, after reducing the power consumption of the subsystem of the device, restoring the subsystem to its previous power consumption level responsive to detecting an eyelid opening.

17. The method of claim 12, wherein the device is a head-mounted display device.

18. A head-mounted display device, comprising:
an eye tracking camera positioned to acquire an image of an eye when worn on a head;
a display device configured to display a user interface;
a logic system; and
a storage system comprising instructions stored thereon that are executable by the logic system to
track gaze direction based upon image data of the eye as acquired by the eye tracking camera;
detect an eyelid closure from the image data;
determine whether the eyelid closure was a blink or an intended user input;
if the eyelid closure is determined to be an intended user input, then take an action based upon a location at which the gaze direction intersects the displayed user interface; and
if the eyelid closure is determined to be a blink, then not take the action.

19. The head-mounted display device of claim 18, wherein the instructions executable to determine whether the eyelid closure was a blink or an intended user input are further executable to determine that the eyelid closure was an intended user input based one or more of a duration of the eyelid closure, a velocity of eyelid movement, an acceleration of eyelid movement, an eyelid pose, and if the eyelid closure occurred at same time as an eye dwell gaze as determined from gaze tracking.

20. The head-mounted display device of claim 18, wherein the instructions are executable to determine a user state based on an eyelid state detected via the image data, and take a user interaction action based upon the user state.
